(19) United States
(12) Patent Application Publication
(10) Pub. No.: US 2006/0116108 A1
(43) Pub. Date: Jun. 1, 2006

(54) Method and devices for transmitting and/or receiving short messages in a fixed network

(75) Inventor: Juergen Meyer, Rotenburg (DE)

Correspondence Address: KENYON & KENYON LLP, ONE BROADWAY, NEW YORK, NY, 10004, US

(73) Assignee: KEIHN CORPORATION

(21) Appl. No.: 10/523,885

(22) PCT Filed: Jul. 11, 2003
(86) PCT No.: PCT/DE03/02333

§ 371 Date: Nov. 4, 2005

(30) Foreign Application Priority Data
Aug. 7, 2002 (DE) 102-36-082.0

(51) Int. Cl. H04Q 7/22

(52) U.S. Cl. 455/412.2

(57) ABSTRACT

A device for transmitting and receiving a short message (SM) in a fixed network in which the device is configured to modulate an SMS signal which is to be sent by FSK (Frequency Shift Keying) and to demodulate an SMS signal which is to be received and which is modulated by FSK (Frequency Shift Keying). The device includes a computer which is programmed in such a manner that it can carry out said modulation and demodulation.

### FIELD OF THE INVENTION

The present invention relates to methods and devices for transmitting and/or receiving short messages (SM) in a fixed network, in which a Short Message Service (SMS) signal to be transmitted is modulated by frequency shift keying (FSK), and an SMS signal that is to be received and was modulated by FSK is demodulated.

### RELATED TECHNOLOGY

The Short Message Service (SMS), available from mobile radio communications, has also been offered for some time in a fixed network, e.g., as a service of Deutsche Telekom AG in its German fixed network. The product “SMS in Fixed Network”, thus, the possibility of transmitting SM in a fixed network, is standardized by the Standard ETSI ES 201 912 V1.1.1 (2002-01) “Access and Terminals (AT); Short Message Service (SMS) for PSTN/ISDN; Short Message Communication Between a Fixed Network Short Message Terminal Equipment and a Short Message Service Centre” (European Telecommunications Standards Institute 2002).

It is believed that the “SMS in Fixed Network” service can only be used with very special telephones, that is, telephones specially designed for that purpose have been needed to send and receive SM in a fixed network.

The interface used for SMS in a fixed network is an analog or ISDN line, via which the signal, modulated by FSK (frequency shift keying) for transmission in accordance with ETSI ES 201 912, is transmitted at 1200 bit/s.

The indicated special SMS-capable fixed-network telephones each have a special hardware chip, in which the respective necessary modulation, demodulation and communications-control devices are configured hardware-wise.

### SUMMARY OF THE INVENTION

The present invention provides methods and devices which permit the use of the “SMS in Fixed Network” service at least partially even without the special telephones necessary for that purpose according to the related art.

With the aid of the methods and devices of the present invention, more customers are able to utilize the “SMS in Fixed Network” service. The customers no longer have to rely so rigidly on the telephones needed according to the related art and provided with the indicated special hardware chip. The customers are thereby able to use the “SMS in Fixed Network” service more conveniently.

In the case of these designs, the end customer can easily fall back upon a voice-capable modem as is commercially available and already installed for a long time at a great number of end users. According to the embodiments of the invention, the “SMS in Fixed Network” service is now also able to operate via this voice-capable modem. The end customer thus can, to a great extent, fall back upon hardware components already at hand, thereby increase their intrinsic value, and reduce investment costs compared to the related art.

### DETAILED DESCRIPTION

In an exemplary embodiment of a method according to the present invention for transmitting an SM in a fixed network, an SMS signal to be transmitted is modulated by FSK (frequency shift keying) by a suitably programmed computer.

One exemplary embodiment of a device according to the present invention is used both for transmitting and for receiving an SM in a fixed network, and is set up so that it is able to carry out the method just indicated. A software program available in the computer simulates the necessary signal behavior on the line. The function of the computer thus programmed is to transmit the signal, modulated by FSK (frequency shift keying) for transmission in accordance with ETSI ES 201 912, at 1200 bit/s.

In the case of the last-named exemplary embodiment of a device according to the present invention, the demodulation of the FSK signals and even the communications control are carried out by the indicated computer which is suitably programmed. For communication with an SMSC (Short Message Service Center), the indicated exemplary embodiment of a device according to the present invention is provided with a voice-capable modem.

In further embodiments of the present invention, a method for transmitting a short message (SM) in a fixed network is provided in which an SMS signal to be transmitted is modulated by FSK (frequency shift keying), wherein the FSK modulation is performed by a suitably programmed computer.

A further embodiment provides a method for receiving a short message (SM) in a fixed network, in which an SMS signal that is to be received and was modulated by FSK (frequency shift keying) is demodulated, wherein the demodulation is performed by a suitably programmed computer.

Further embodiments of the invention described herein can include at least one of: a computer which at least partially takes over the communications control; the use of a voice-capable modem for communication with an SMSC (Short Message Service Center); and wherein the signal transmission takes place at a rate of 1200 bit/s.

Further embodiments of the invention provide a device for transmitting a short message (SM) in a fixed network, the device being set up so that, using FSK (frequency shift keying), it modulates an SMS signal to be transmitted, wherein the device has a computer which is programmed so that it is able to perform the FSK modulation.

Further embodiments of the invention provide a device for receiving a short message (SM) in a fixed network, the device being set up so that it demodulates an SMS signal to be received that was modulated by FSK (frequency shift keying), wherein the device has a computer which is programmed so that it is able to perform the indicated demodulation.

Further embodiments of the invention provide a device for transmitting and receiving a short message (SM) in a fixed network, the device being set up so that, using FSK (frequency shift keying), it modulates an SMS signal to be transmitted, and demodulates an SMS signal to be received that was modulated by FSK (frequency shift keying), wherein the device has a computer which is programmed so that it is able to perform both the indicated modulation and the indicated demodulation.

Further embodiments of the invention described herein include at least one of: a computer which is set up so that it can at least partially take over the communications control; a voice-capable modem for communication with an SMSC (Short Message Service Center); and a computer having an ISDN card.

What is claimed is:

1 to 11. (canceled)

12. A method for transmitting a short message in a fixed network, comprising:
modulating a Short Message Service (SMS) signal to be transmitted by a frequency shift keying (FSK), wherein the frequency shift keying modulation is performed by a suitably programmed computer.

13. A method for receiving a short message (SM) in a fixed network,
receiving a Short Message Service (SMS) signal;
modulating the Short Message Service (SMS) signal by a frequency shift keying (FSK);
demodulating the Short Message Service (SMS) signal, wherein the demodulation is performed by a suitably programmed computer.

14. The method as recited in claim 12, wherein the computer at least partially takes over the communications control.

15. The method as recited in claim 12, further comprising:
using a voice-capable modem for communication with a Short Message Service Center (SMSC).

16. The method as recited in claim 12, wherein the signal transmission takes place at a rate of 1200 bit/s.

17. The method as recited in claim 13, wherein the computer at least partially takes over the communications control.

18. The method as recited in claim 13, further comprising:
using a voice-capable modem for communication with a Short Message Service Center (SMSC).

19. The method as recited in claim 13, wherein the signal transmission takes place at a rate of 1200 bit/s.

20. A device for transmitting a short message (SM) in a fixed network, comprising:
a computer programmed to be able to perform a frequency shift keying modulation, wherein the device being set up so that, using a frequency shift keying (FSK), it modulates a Service Message Service (SMS) signal to be transmitted.

21. The device as recited in claim 20, wherein the computer is set up so that it can at least partially take over the communications control.

22. The device as recited in claim 20, further comprising a voice-capable modem for communication with a Short Message Service Center (SMSC).

23. The device as recited in claim 20, wherein the computer has an ISDN card.

24. A device for receiving a short message (SM) in a fixed network, comprising:
a computer programmed to be able to demodulate a Signal Message Service (SMS) signal to be received that was modulated by a frequency shift keying (FSK).

25. The device as recited in claim 24, wherein the computer is set up so that it can at least partially take over communications control.

26. The device as recited in claim 24, further comprising a voice-capable modem for communication with a Short Message Service Center (SMSC).

27. The device as recited in claim 24, wherein the computer has an ISDN card.

28. A device for transmitting and receiving a short message (SM) in a fixed network, comprising:
a computer programmed to be able to perform a modulation, using frequency shift keying (FSK), of a Short Message Service (SMS) signal to be transmitted, and is able to perform a demodulation of the Short Message Service (SMS) signal to be received that was modulated by the frequency shift keying (FSK).

29. The device as recited in claim 28, wherein the computer is set up so that it can at least partially take over the communications control.

30. The device as recited in claim 28, further comprising a voice-capable modem for communication with a Short Message Service Center (SMSC).

31. The device as recited in claim 28, wherein the computer has an ISDN card.
